(19) United States
(12) Patent Application Publication
(10) Pub. No.: US 2016/0180977 A1
(43) Pub. Date: Jun. 23, 2016

(54) NEUTRON MEASUREMENT APPARATUS AND NEUTRON MEASUREMENT METHOD

(71) Applicant: Kabushiki Kaisha Toshiba, Minato-ku (JP)

(72) Inventors: Daijiro ITO, Kodaira (JP); Norihiro UMEMURA, Fuchu (JP); Shigehiro KONO, Tama (JP); Tsuyoshi KUMAGAI, Fuchu (JP); Makoto TOMITAKA, Saitama (JP)

(73) Assignee: Kabushiki Kaisha Toshiba, Minato-ku (JP)

(21) Appl. No.: 14/954,040

(22) Filed: Nov. 30, 2015

(30) Foreign Application Priority Data
Dec. 17, 2014 (JP) 2014-255178

(51) Int. Cl. G21C 17/108

(52) U.S. Cl. CPC G21C 17/108

(57) ABSTRACT

According to an embodiment, a neutron measurement apparatus has a neutron detector; a pre-amplifier; a first AC amplifier which extracts and amplifies an AC component; a bandwidth limiter which obtains a signal of a range of a predetermined frequency domain based on the output of the first AC amplifier; a neutron signal interval calculation unit which derives a neutron signal interval, that is a period of time during which a significant signal is being generated, from the AC component of the neutron detection signal; and a mean square value calculation unit which calculates a mean square value of outputs of the bandwidth limiter for a range corresponding to the neutron signal interval.

### CROSS-REFERENCE TO RELATED APPLICATIONS

This application is based upon and claims the benefit of priority from Japanese Patent Application No. 2014-255178 filed on Dec. 17, 2014, the entire content of which is incorporated herein by reference.

### FIELD

The present embodiments relate to a neutron measurement apparatus and a neutron measurement method.

### BACKGROUND

In many cases, neutrons generated in a nuclear reactor or a nuclear fusion experimental system are less likely to be affected by radiation or circuit noise in the background. So, those neutrons are measured by a fission counter tube. The fission counter tube generates one pulse signal each time one neutron is detected. When the neutron flux is low, a pulse counting method, by which each of the pulse signals generated from the fission counter tube is counted, is used to measure neutrons.

When the neutron flux is relatively high, the pulse signals are frequently generated due to the detection of neutrons. In such a case, the pulse signals are superimposed on each other (or piled up), making it impossible to count each pulse signal. Under such circumstances, it is known that Campbell method, which makes use of the fact that statistical fluctuations of the superimposed pulse signals output from a detector have a proportional relationship with the neutron flux, is used to measure neutrons. In recent years, a neutron measurement method that uses digital signal processing technology has been put to practical use: by digitalize the signals (detector output signals) that are output from a detector. Refer to Japanese Patent Application Laid-Open Publication No. H5-215860, for example, the entire content of which is incorporated herein by reference.

### BRIEF DESCRIPTION OF THE DRAWINGS

FIG. 1 is a block diagram showing the overall configuration of a neutron measurement apparatus according to a first embodiment.

FIG. 2 is a block diagram showing the overall configuration of a neutron measurement apparatus according to a modified example of the first embodiment.

FIG. 3 is a flowchart showing the procedure of a neutron measurement method according to the first embodiment.

FIG. 4 is a graph showing an output waveform of each unit of the neutron measurement apparatus according to the first embodiment.

FIG. 5 is a block diagram showing the overall configuration of a neutron measurement apparatus according to a second embodiment.

FIG. 6 is a block diagram showing the overall configuration of a neutron measurement apparatus according to a third embodiment.

FIG. 7 is a graph for explaining how the delay occurs due to the processing by the wave height discriminator.

FIG. 8 is a block diagram showing the configuration of a conventional neutron measurement apparatus.

### DETAILED DESCRIPTION

In the neutron measurement that employs the Campbell method, to calculate statistical fluctuations of the detector output signals, the mean square value of AC components of the detector output signals is calculated. Usually, what are superimposed on the detector output signals are not only signals of neutrons but also background components stemming from radiation or circuit noise, which is different from neutrons. If the AC component of signal voltage of neutrons is represented by Vn(t), the AC component of the background component by Vo(t), and the AC component of voltage of all the superimposed signals by Vs(t) as functions of time t, and if the measurement start time is 0 and the measurement duration time T, the mean square value is expressed by following equation (1):

$$\frac{1}{T} {\int }_{0}^{T} {V}_{s}^{2} ( t ) d t = \frac{1}{T} {\int }_{0}^{T} {( {V}_{n} ( t ) + {V}_{o} ( t ) )}^{2} d t = \frac{1}{T} {\int }_{0}^{T} {V}_{n}^{2} ( t ) d t + \frac{2}{T} {\int }_{0}^{T} {V}_{n} ( t ) \cdot {V}_{o} ( t ) d t + \frac{1}{T} {\int }_{0}^{T} {V}_{o}^{2} ( t ) d t \qquad ( 1 )$$

In the right-hand side of equation (1), there is no correlation between Vn(t) and Vo(t). Accordingly, the function inner product is 0. Therefore, following equation (2) can be established:

∫₀^{T}Vₙ(t)·Vₒ(t)dt=0 (2)

Accordingly, the second term on the right-hand side of equation (1) is 0, and following equation (3) is therefore established. Equation (3) proves that the sum of the mean-square voltage of signals associated with neutrons and mean-square voltage of signals associated with background radiation and circuit noise is equal to the mean-square voltage of all the signals.

$$\frac{1}{T} {\int }_{0}^{T} {V}_{s}^{2} ( t ) d t = \frac{1}{T} {\int }_{0}^{T} {V}_{n}^{2} ( t ) d t + \frac{1}{T} {\int }_{0}^{T} {V}_{o}^{2} ( t ) d t \qquad ( 3 )$$

From equation (3), it is clear that the mean square value of the background component of the right-hand side of equation (3) is a difference between the mean square value of a measured value and the mean square value of a true value. When the neutron flux is relatively high, the mean square voltage of signals associated with neutrons is sufficiently larger than the difference between the measured and true values. Therefore, the difference can be neglected, and the proportional relation between the statistical fluctuations and the neutron flux is maintained. When the neutron flux is relatively low, the difference between the measured and true values is somewhat larger relative to the mean square voltage of signals associated with neutrons. Therefore, the statistical fluctuations and the neutron flux break out of the proportional relation. In this case, it is difficult to measure the neutron flux.

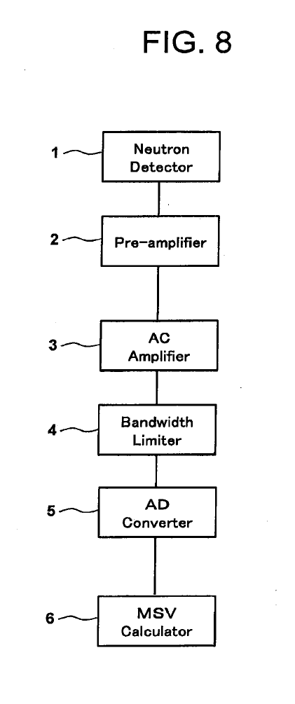

FIG. 8 is a block diagram showing the configuration of a conventional neutron measurement apparatus. As shown in FIG. 8, in a signal processing circuit that processes a detector output signal (analog signal), a pre-amplifier 2, a first AC amplifier 3, a bandwidth limiter 4, and an MSV (mean square value) calculator 6 are provided in order to measure neutrons. At this time, typical anti-noise measures, such as inserting a ferrite core into a signal transmission line, are taken to reduce the background component. However, in the conventional neutron measurement apparatus, the effect of background-component reduction achieved by the typical anti-noise measures is limited. Therefore, the influence of the background component cannot be sufficiently removed, and it is difficult to accurately measure the neutron flux when the neutron flux is relatively low.

The object of embodiments of the present invention is to measure the neutron flux even when the level of the neutron flux is relatively low by suppressing the influence of the background component.

According to an embodiment, there is provided a neutron measurement apparatus comprising: a neutron detector to generate an output signal corresponding to an incoming neutron; a pre-amplifier to amplify the output signal of the neutron detector and to output a neutron detection signal; a first AC amplifier to extract and to amplify an AC component of the output of the pre-amplifier; a bandwidth limiter to obtain a signal of a range of a predetermined frequency domain based on the output of the first AC amplifier; a neutron signal interval calculation unit to derive a neutron signal interval, which is a period of time during which a significant signal is being generated, from the AC component of the neutron detection signal; and a mean square value calculation unit to calculate a mean square value of outputs of the bandwidth limiter for a range corresponding to the neutron signal interval.

According to another embodiment, there is provided a neutron measurement method comprising: a pulse length conversion step of: extracting, in a second AC amplifier, an AC component based on a signal amplified by a pre-amplifier; carrying out wave-height discrimination; and deriving a neutron signal interval based on a result of the wave-height discrimination; an extraction step of: amplifying, in a pre-amplifier, an output signal of a neutron detector; extracting and amplifying, in a first AC amplifier, an AC component; and then obtaining an AC component of a range of a predetermined frequency domain by using a bandwidth limiter; and a mean square value calculation step of calculating a mean square value of the AC components, by a mean square value calculation unit, for a range corresponding to a time section that is derived as the neutron signal interval.

Hereinafter, with reference to the accompanying drawings, embodiments of a neutron measurement apparatus and a neutron measurement method of the present invention will be described. The same or similar portions are represented by the same reference symbols, and a duplicate description will be omitted.

### First Embodiment

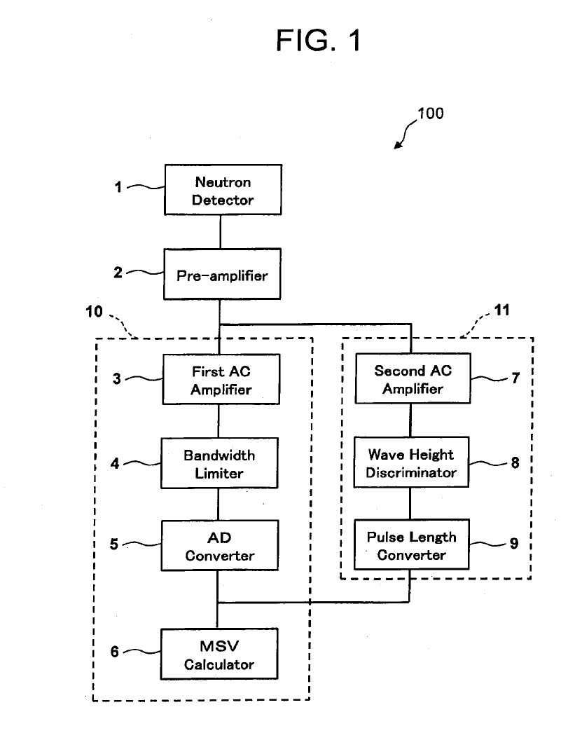

FIG. 1 is a block diagram showing the overall configuration of a neutron measurement apparatus according to a first embodiment. A neutron measurement apparatus 100 of the present embodiment is designed to measure the intensity of neutrons of a reactor core in a range that is lower than a range (power range) where an output power of a nuclear reactor is close to a rated power, or in a so-called start-up range where the level of a neutron flux is relatively low. The neutron measurement apparatus 100 includes a neutron detector 1, a pre-amplifier 2, a Campbell measurement circuit 10, and a neutron signal interval calculation unit 11.

The neutron detector 1 is a detector that detects neutrons. The neutron detector 1 outputs a pulse-like electrical signal (referred to as neutron pulse, hereinafter) when one neutron is input. The pre-amplifier 2 amplifies signals from the neutron detector 1 in order to transmit the output of the neutron detector 1 to a control panel or the like, which is not shown in the diagram.

The Campbell measurement circuit 10 includes a first AC amplifier 3, a bandwidth limiter 4, an AD converter 5, and a mean square value (MSV) calculation unit (MSV calculator) 6. The Campbell measurement circuit 10 is a circuit that measures, based on the Campbell method, the level of a neutron flux.

The first AC amplifier 3 receives, as an input, a signal from the pre-amplifier 2, extracts an AC component, and amplifies. The bandwidth limiter 4 receives, as an input, an output of the first AC amplifier 3, and filters waves of only alternating current of a predetermined frequency band while allowing alternating current of other frequency ranges to attenuate. The AD converter 5 outputs, when an output signal of the bandwidth limiter 4 is input, a value obtained by converting the input signal into a digital value, at certain intervals. The MSV calculator 6 is designed to obtain a mean square value. The MSV calculator 6 receives, as inputs, an output signal of the AD converter 5 and an output signal of a pulse length converter 9, which is described later, and outputs a mean square value. In this case, the mean square value is a moving average for a predetermined duration time.

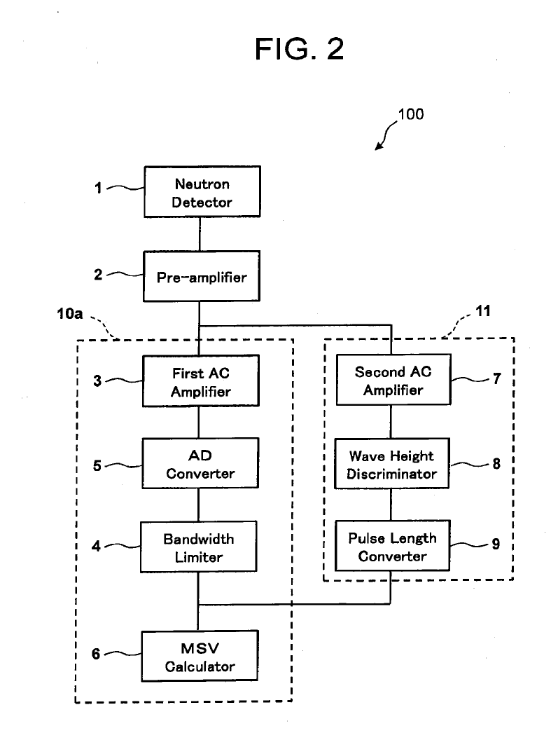

FIG. 2 is a block diagram showing the overall configuration of a neutron measurement apparatus according to a modified example of the first embodiment. In the modified example, the AD converter 5 is followed by the bandwidth limiter 4. That is, in a Campbell measurement circuit 10a, an output of the first AC amplifier 3 goes through AD conversion in the AC converter 5 before being input to the bandwidth limiter 4. In this modified example, the bandwidth limiter 4 can employ a digital filter. Therefore, it is possible to sufficiently block passage of waves other than those of a frequency range that is supposed to pass.

Next, an operation of the first embodiment is described.

The neutron signal interval calculation unit 11 shown in FIG. 1 includes a second AC amplifier 7, a wave height discriminator 8, and a pulse length converter 9. The second AC amplifier 7 receives, as an input, a signal from the pre-amplifier 2, extracts an AC component, and amplifies. The wave height discriminator 8 is designed to detect the generation of a neutron pulse. The wave height discriminator 8 receives, as an input, an output signal of the second AC amplifier 7, compares the wave height of the input signal with a wave height that has been determined in advance based on one neutron pulse, and outputs one logic pulse signal. For example, when the wave height of the input signal is greater than the predetermined wave height, the logic pulse signal is ON. When the wave height of the input signal is less than the predetermined wave height, the logic pulse signal is OFF.

The pulse length converter 9 is designed to adjust the length of the logic pulse. When an output signal (logic pulse) of the wave height discriminator 8 is input, the pulse length converter 9 outputs a logic pulse that keeps going for a certain duration time.

In this case, as described later, the neutron signal interval does not refer to a period of time for only generation of noise, but to a period of time when significant signals are being received from the neutron detector 1. That is, the neutron signal interval could also be a period of time when the MSV calculator 6 should calculate the mean square of signals.

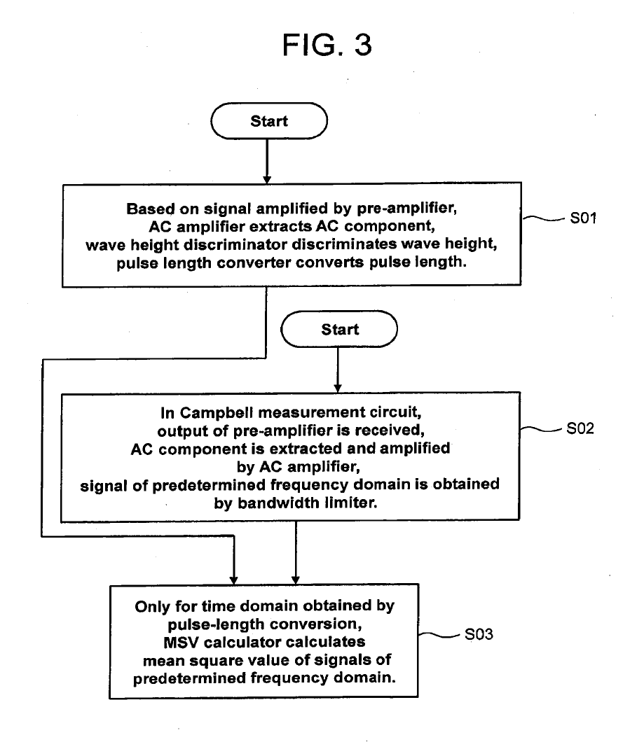

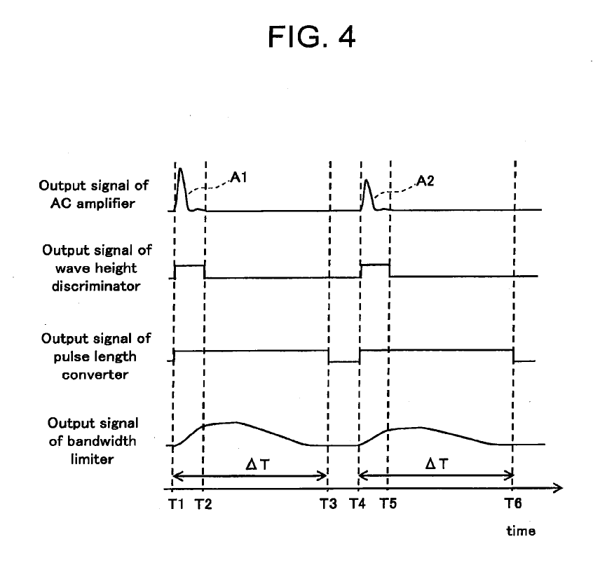

FIG. 3 is a flowchart showing the procedure of a neutron measurement method according to the first embodiment. FIG. 4 is a graph showing an output waveform of each unit of the neutron measurement apparatus according to the first embodiment. The horizontal axis represents time. The vertical axis in the top portion represents the output of the second AC amplifier 7. The vertical axis in the second from the top represents the output of the wave height discriminator 8. The vertical axis in the third from the top represents the output of the pulse length converter 9. The vertical axis in the fourth from the top represents the output of the bandwidth limiter 4. The operation of the present embodiment will be described with reference to FIGS. 3 and 4.

First, based on the signal amplified by the pre-amplifier 2, the second AC amplifier 7 extracts the AC component. The wave height discriminator 8 carries out wave-height discrimination by comparing the AC component with a predetermined, specified value. The pulse length converter 9 carries out converting pulse length on a result of the wave-height discrimination (Step S01).

A weak neutron pulse that is generated by the neutron detector 1 is amplified by the pre-amplifier 2. An output signal that is produced by superimposed neutron pulses from the pre-amplifier 2 contains an unstable DC component. The unstable DC component could be a factor in generating unnecessary electric current through the circuit. The second AC amplifier 7 removes the unnecessary DC component from the input signal, and extracts only the AC component.

The outline of the neutron pulse that emerges after only the AC component is extracted is shown in section “Output signal of AC amplifier” in FIG. 4. FIG. 4 shows the case where one neutron pulse A1 is generated at time T1, and another neutron pulse A2 is generated at time T4. In this case, a frequency component that the neutron pulses contain is represented by fn.

In parallel with step S01, in the Campbell measurement circuit 10, an output of the pre-amplifier 2 is received, and an AC component is extracted and amplified by the first AC amplifier 3, and a signal of a range of a predetermined frequency domain is obtained by the bandwidth limiter 4 (Step S02).

FIG. 4 shows the case where the frequency band that is allowed to pass after filtering of the bandwidth limiter 4 is set to a band that is smaller than fn. That is, time interval ΔT during which the neutron pulse that passes through the bandwidth limiter 4 continues is longer than the time interval during which the neutron pulse that is the output signal of the second AC amplifier 7 continues. The time interval ΔT is a constant value because the time interval ΔT is determined based on frequency characteristics of the bandwidth limiter 4. The neutron signal interval calculation unit 11 is used to detect an interval of time during which the neutron pulse is being generated in the output signal of the bandwidth limiter 4.

The wave height discriminator 8 of the neutron signal interval calculation unit 11 outputs one logic pulse as shown in section “Output signal of wave height discriminator” in FIG. 4, at a time when the output signal of the second AC amplifier 7 has reached a predetermined threshold value due to the generation of the neutron pulse. Accordingly, the generation of the logic pulse indicates the time when the neutron pulse is generated.

As the logic pulse is input to the pulse length converter 9, the logic signal output from the pulse length converter 9 is inverted from low to high. The logic that has been inverted to high returns to the original logic after time ΔT has passed. As a result, the logic state (high/low) of the output signal of the pulse length converter 9 represents whether or not the neutron pulse is generated on the output signal of the bandwidth limiter 4, as shown in FIG. 4.

The time interval ΔT is determined based on frequency characteristics of the bandwidth limiter 4. It is possible to calculate the time interval ΔT in advance, to set the time required for the logic to go back to low after being inverted to high can as ΔT in the pulse length converter 9.

Then, only for a time domain obtained by the pulse-length conversion, the mean square value of signals of a range of a predetermined frequency domain is calculated (Step S03). The MSV calculator 6 of the Campbell measurement circuit 10 uses only digital value Vs[t], which is obtained during a period of time when the neutron pulse is being generated, that is a period of time when the logic state of the output signal of the pulse length converter 9 is high, and to calculate mean square value MSV0 of signals of measurement time T with following equation (4):

$$MSV 0 = \frac{1}{T} {\sum }_{t} {V}_{s}^{2} [ t ] \qquad ( 4 )$$

The calculated mean square value MSV0 is converted into neutron flux after being multiplied by a conversion coefficient, and is then output.

According to the present embodiment described above, only a signal value (e.g., voltage value) that is measured during a period of time when the neutron pulse is being generated is used for the mean-square calculation. Therefore, even if the neutron flux is low, the effects of the voltage value measured during a period of time when there is no neutron pulse can be removed. As a result, it is possible to measure a value closer to a true value.

In conventional neutron measurement apparatus that simultaneously use both the pulse counting method and the Campbell method to keep a wide measurement range, such as a start-up range monitor of a nuclear reactor, an additional circuit needs to be installed in order to simultaneously use both the methods. Meanwhile, the application of the present embodiment makes it possible to measure only with the Campbell method, and the pulse counting method is not required. Therefore, there is no need to mount a circuit for the pulse counting method and a circuit for simultaneously using both the methods. Thus, the mountability can be improved.

When both the pulse counting method and the Campbell method are simultaneously used, an integrated circuit, such as FPGA (Field Programmable Gate Array), is frequently used as means to realize the MSV calculator 6. All the circuits that should be added to carry out the present invention can be mounted on such an integrated circuit. Therefore, without increasing the size of the circuit board, the present embodiment can be applied to extend the measurement range of the Campbell method.

### Second Embodiment

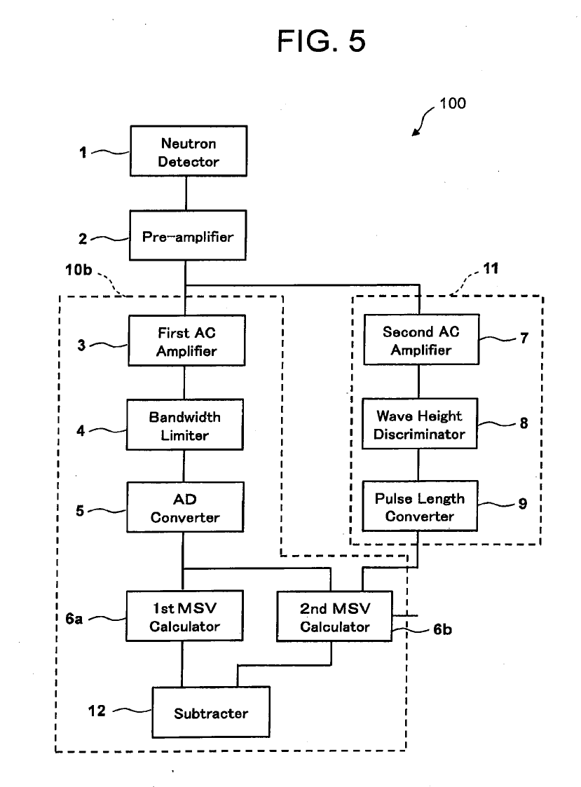

FIG. 5 is a block diagram showing the overall configuration of a neutron measurement apparatus according to a second embodiment. The present embodiment is a variant of the first embodiment. According to the second embodiment, a Campbell measurement circuit 10b includes a first MSV calculator 6a, a second MSV calculator 6b, and a subtracter 12.

The first MSV calculator 6a is designed to calculate a mean square value of signals. Regardless of whether or not a neutron pulse is being generated, all digital values that are obtained during measurement time T are used to calculate mean square value MSV1, which is then output.

The second MSV calculator 6b is to calculate a mean square value of signals. The second MSV calculator 6b receives, as inputs, an output signal of the AD converter 5 and an output signal of the pulse length converter 9, and then outputs a mean square value. The second MSV calculator 6b uses a digital value that is an output signal of the AD converter 5 for a period of time when no neutron pulse is generated or when the logic state of the output signal of the pulse length converter 9 is low, in order to calculate and output mean square value MSV2.

The subtracter 12 is designed to calculate a difference between the mean square values. After mean square value MSV1 that is output from the first MSV calculator 6a and mean square value MSV2 that is output from the second MSV calculator 6b are input, the subtracter 12 calculates and outputs the difference between the mean square values (MSV1-MSV2).

According to the present embodiment, from mean square value MSV1 of signals for all periods of time, mean square value MSV2 of signals for a period of time when no neutron signal is being generated is subtracted. Therefore, even if the neutron flux is low, the effects of the voltage value measured during a period of time when there is no neutron pulse can be removed. As a result, it is possible to measure a value closer to a true value.

### Third Embodiment

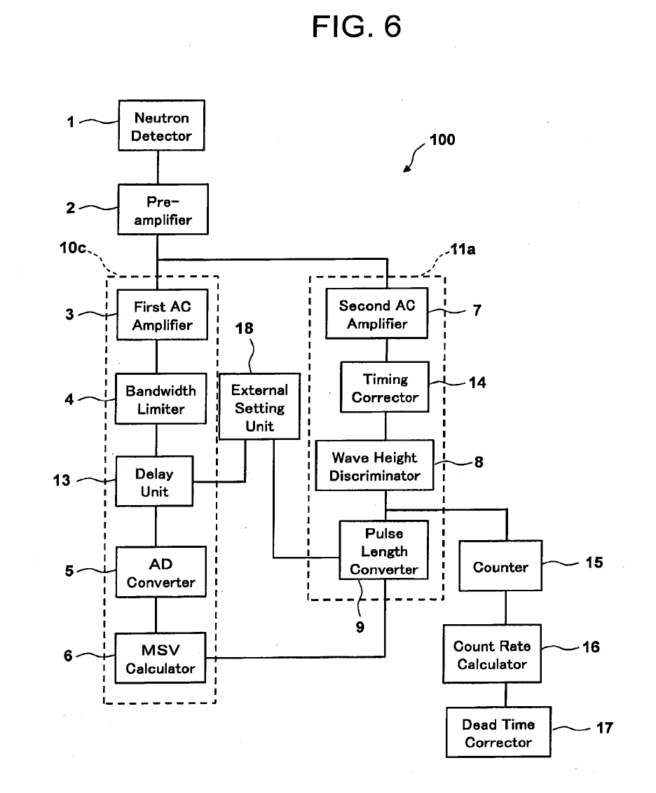

FIG. 6 is a block diagram showing the overall configuration of a neutron measurement apparatus according to a third embodiment. The present embodiment is a variant of the first embodiment.

A Campbell measurement circuit 10c of the present embodiment includes a delay unit 13. A neutron signal interval calculation unit 11a includes a timing corrector 14. In addition to these units, a neutron measurement apparatus 100 includes a counter 15, a count rate calculator 16, a dead time corrector 17, and an external setting unit 18.

The delay unit 13 of the Campbell measurement circuit 10c is designed to delay signals for a certain time. When an output signal of the bandwidth limiter 4 is input, the delay unit 13 outputs the output signal of the bandwidth limiter 4 after a certain time. That is, the delay unit 13 compensates for a delay in the processing by the neutron signal interval calculation unit 11a with respect to the processing by the Campbell measurement circuit 10c.

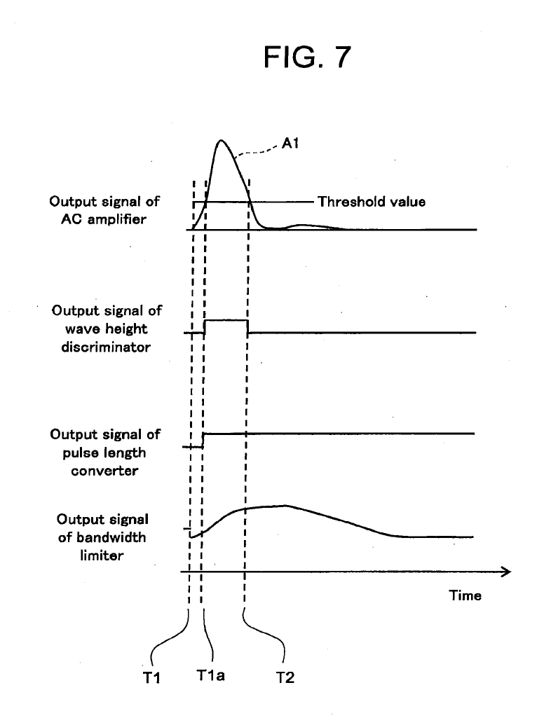

For example, the delay in the processing is attributable to the processing by the wave height discriminator 8 of the neutron signal interval calculation unit 11a. FIG. 7 is a graph for explaining how the delay occurs due to the processing by the wave height discriminator. As shown in FIG. 7, the output signal of the second AC amplifier 7 starts to rise at time T1. In this case, in the neutron signal interval calculation unit 11a, the wave height discriminator 8 is turned ON at time T1a when the output signal of the second AC amplifier 7 exceeds a predetermined threshold value. As a result, the logic signal of the pulse length converter 9, too, is turned ON at time T1a.

Meanwhile, in the Campbell measurement circuit 10c, at the same time, T1, when the output signal of the first AC amplifier 3 rises, an output signal is generated from the bandwidth limiter 4. In this manner, while the pulse signal is generated at time T1, the neutron signal interval calculation unit 11a starts outputting at time T1a. Thus, a delay of (T1a-T1) is generated. In order to compensate for a time lag, including that delay, the delay unit 13 is provided in the Campbell measurement circuit 10c.

The counter 15 is designed to count the neutron pulses. As the logic pulse that is output from the wave height discriminator 8 is input, the counter 15 adds one to an accumulated value, and outputs the added accumulated value. The count rate calculator 16 is designed to calculate a count rate. As the accumulated value that is output from the counter 15 is input, the count rate calculator 16 outputs the count rate. The dead time corrector 17 is designed to correct an error of the count rate. As the count rate that is output from the count rate calculator 16 is input, the dead time corrector 17 outputs the corrected count rate. The counter 15, the count rate calculator 16, and the dead time corrector 17 provide a function of obtaining the count rate with the use of the pulse count method and performing a dead time correction process.

The counter 15 counts the number of neutron pulses; the count rate calculator 16 calculates the count rate by dividing the number by the time when the counted value is counted. However, no correction has been made to the obtained count rate as for a period of time when the sensitivity of the counter is lost. Accordingly, the dead time corrector 17 will make a correction. The dead time correction is expressed by following equation (5) if the post-correction count rate is represented by Rc, the pre-correction count rate by R, and the dead time by τ:

Rc=N/(T−N·τ)=R/(1−R·τ) (5)

where N represents a count value in duration time T; R=N/T.

The external setting unit 18 allows the length of the logic pulse output from the pulse length converter 9 and the delay time for which the signal is delayed by the delay unit 13 to be set from the outside. When setting values of the logic pulse the length and the delay time are input from the outside, the external setting unit 18 outputs each of the setting values to the delay unit 13 and pulse length converter 9. When the setting values are input into the external setting unit 18, the delay time for which the signal is delayed by the delay unit 13 and the length of the logic pulse output from the pulse length converter 9 are changed to the setting values.

The timing corrector 14 of the neutron signal interval calculation unit 11a uses a timing correction method, such as zero-crossing method or constant fraction method, to correct the deviation of the time of detecting the neutron pulse.

According to the present embodiment described above, the dead time correction process has been applied. Therefore, in using both the Campbell method and the pulse count method, a region where each of the measurement ranges of the two overlaps with each other can be made wider than before. Moreover, the timing corrector 14 and the delay unit 13 can eliminate the deviation of the pulse generation time detection, which is caused by fluctuations in the height of pulse waves.

Furthermore, the external setting unit 18 allows the setting values to be fine-tuned at a time of calibrating or adjusting the device.

### Other Embodiments

While several embodiments of the present invention have been described, these embodiments have been presented by way of example and are not intended to limit the scope of the inventions. For example, what has been described in the embodiments is the case where the level of neutron flux is measured in the start-up range. However, the application is not limited to this as long as the principles of the inventions are utilized. Moreover, features of the embodiments may be used in combination.

The embodiments may be embodied in other various forms. Various omissions, replacements and changes may be made without departing from the subject-matter of the invention.

The above embodiments and variants thereof are within the scope and subject-matter of the invention, and are similarly within the scope of the invention defined in the appended claims and the range of equivalency thereof.

What is claimed is:

1. A neutron measurement apparatus comprising:
a neutron detector to generate an output signal corresponding to an incoming neutron;
a pre-amplifier to amplify the output signal of the neutron detector and to output a neutron detection signal;
a first AC amplifier to extract and to amplify an AC component of the output of the pre-amplifier;
a bandwidth limiter to obtain a signal of a range of a predetermined frequency domain based on the output of the first AC amplifier;
a neutron signal interval calculation unit to derive a neutron signal interval, which is a period of time during which a significant signal is being generated, from the AC component of the neutron detection signal; and
a mean square value calculation unit to calculate a mean square value of outputs of the bandwidth limiter for a range corresponding to the neutron signal interval.

2. The neutron measurement apparatus according to claim 1, wherein
the neutron signal interval calculation unit includes:
a second AC amplifier to extract and to amplify an AC component of the output of the pre-amplifier;
a wave height discriminator to classify wave heights into predetermined ranges based on an output of the second AC amplifier; and
a pulse length converter to derive the neutron signal interval based on an output of the wave height discriminator and to output a pulse signal corresponding to the neutron signal interval.

3. The neutron measurement apparatus according to claim 1, further comprising
a subtracter to subtract, from a value that the mean square value calculation unit has calculated by integrating mean square values during all periods of time based on signals filtered by the bandwidth limiter, a value that the mean square value calculation unit has calculated in a section where any signal filtered by the bandwidth limiter is not being generated by integrating mean square values based on signals filtered by the bandwidth limiter.

4. The neutron measurement apparatus according to claim 1, further comprising
a delay unit that corrects differences of start times between calculation processes in the neutron signal interval calculation unit and the units leading up to the bandwidth limiter.

5. A neutron measurement method comprising:
a pulse length conversion step of: extracting, in a second AC amplifier, an AC component based on a signal amplified by a pre-amplifier; carrying out wave-height discrimination; and deriving a neutron signal interval based on a result of the wave-height discrimination;
an extraction step of: amplifying, in a pre-amplifier, an output signal of a neutron detector; extracting and amplifying, in a first AC amplifier, an AC component; and then obtaining an AC component of a range of a predetermined frequency domain by using a bandwidth limiter; and
a mean square value calculation step of calculating a mean square value of the AC components, by a mean square value calculation unit, for a range corresponding to a time section that is derived as the neutron signal interval.

6. The neutron measurement method according to claim 5, wherein
the neutron signal interval is calculated as a duration time of a signal filtered by the bandwidth limiter since an input generation of the wave-height discrimination.

7. The neutron measurement method according to claim 5, wherein
at the mean square value calculation step, the mean square value is calculated by integrating, across the neutron signal interval, signals filtered by the bandwidth limiter.

8. The neutron measurement method according to claim 5, wherein
at the mean square value calculation step, the mean square value is calculated by subtracting, from a value calculated by integrating signals filtered by the bandwidth limiter during all periods of time, a value calculated in a section where any signal filtered by the bandwidth limiter is not being generated by integrating signals filtered by the bandwidth limiter.
